(19) United States
(12) Patent Application Publication
(10) Pub. No.: US 2020/0242617 A1
(43) Pub. Date: Jul. 30, 2020

(54) METHODS AND SYSTEMS FOR PERFORMING PAYMENT TRANSACTIONS WITHOUT A POINT OF SALE TERMINAL

(71) Applicant: Mastercard International Incorporated, Purchase, NY (US)

(72) Inventors: Rajeev Kumar, Varanasi (IN); Vivek Dudani, Sydney (AU)

(73) Assignee: Mastercard International Incorporated, Purchase, NY (US)

(21) Appl. No.: 16/750,965

(22) Filed: Jan. 23, 2020

(30) Foreign Application Priority Data
Jan. 28, 2019 (SG) 10201900785X

(51) Int. Cl. G06Q 20/40; G06Q 20/20; G06Q 20/12

(52) U.S. Cl. CPC G06Q 20/4097; G06Q 20/405; G06Q 20/12; G06Q 20/20

(57) ABSTRACT

Embodiments provide a method for performing a payment transaction at a merchant facility. The method includes receiving a connectivity request from an electronic payment card associated with a cardholder at a merchant networking device associated with a merchant. The method includes facilitating pairing of the electronic payment card with the merchant networking device. The method also includes upon pairing, pushing payment related information of the merchant to the electronic payment card. The method further includes receiving a payment transaction request for a payment transaction from the electronic payment card at the merchant networking device. The payment transaction request includes at least a payment card information of the electronic payment card of the cardholder and a transaction amount to be paid to an acquirer account from an issuer account of the cardholder. The method includes facilitating processing of the payment transaction based on the payment transaction request.

### CROSS REFERENCE TO RELATED APPLICATIONS

This application claims priority to Singaporean Application Serial No. 10201900785X, filed Jan. 28, 2019, which is incorporated herein by reference in its entirety

### TECHNICAL FIELD

The present disclosure relates to payment technology and, more particularly to, methods and systems for performing a payment transaction at a merchant facility without accessing a Point-of-Sale (POS) terminal.

### BACKGROUND

With retail outlets embracing digital payment techniques for performing transactions, users are provided with a simple and convenient way to pay for goods/services purchased at the retail outlets. Moreover, ease in use of payment cards (e.g., credit card, debit card) for performing financial transactions at Point-of-Sale (POS) terminals of merchant facilities such as, retail establishments, online stores or business establishments that handle cash or credit transactions has spared users the hassle of carrying cash in their wallets.

The deployment of POS terminals at retail locations for processing payment transactions with payment cards has revolutionized the method of performing transactions for the goods/services purchased by users at a merchant facility. In a typical POS transaction involving payment cards, a cardholder stands in a queue and waits for his/her turn to perform a transaction at a POS terminal. On reaching the POS terminal, the cardholder presents his payment card to an agent at the merchant facility who swipes the payment card to read payment card information. Conventionally, the payment card used for performing payment transactions remains offline when not in use and is activated when inserted into a card reading module of the POS terminal. The agent may provide the transaction amount and process the payment transaction. However, there are times when a user has to stand in a queue for an extended period of time to pay for the goods/services at the POS terminal. The user may not be prepared in certain circumstances to wait for the extended time and pay for the goods/services purchased. Moreover, faulty machines and network connectivity issues of the POS terminal may also delay the payment transaction at the merchant facility.

In view of the above discussion, there exists a need for more convenient techniques for performing payment transactions at the merchant facilities.

### SUMMARY

Various embodiments of the present disclosure provide methods and systems for performing payment transactions at a merchant with an electronic payment card via a merchant networking device.

In an embodiment, a method for performing a payment transaction at a merchant facility is disclosed. The method includes receiving a connectivity request from an electronic payment card associated with a cardholder at a merchant networking device associated with a merchant. The method includes facilitating pairing of the electronic payment card with the merchant networking device. The method also includes upon pairing, pushing payment related information of the merchant to the electronic payment card. The method further includes receiving a payment transaction request for a payment transaction from the electronic payment card at the merchant networking device. The payment transaction request includes at least a payment card information of the electronic payment card of the cardholder and a transaction amount to be paid to an acquirer account from an issuer account of the cardholder. The method includes facilitating processing of the payment transaction based on the payment transaction request.

In another embodiment, a merchant networking device for facilitating payment transactions at a merchant facility is disclosed. The merchant networking device includes a memory comprising stored instructions and at least one processor configured to execute the stored instructions to cause the merchant networking device to perform at least: (1) receiving a connectivity request from an electronic payment card associated with a cardholder, the cardholder being in vicinity of the merchant facility; (2) facilitating pairing of the electronic payment card; (3) upon pairing, pushing merchant information of a merchant associated with merchant the merchant facility to the electronic payment card; (4) receiving a payment transaction request for a payment transaction from the electronic payment card, the payment transaction request comprising at least a payment card information of the electronic payment card of the cardholder and a transaction amount to be paid to an acquirer account from an issuer account of the cardholder; and (5) facilitating processing of the payment transaction based on the payment transaction request.

In yet another embodiment an electronic payment card for performing payment transactions at a merchant facility is disclosed. The electronic payment card includes a communication module and a processing system. The communication module is configured to (1) send a connectivity request to a merchant networking device associated with a merchant for pairing with the merchant networking device, wherein a local identifier is assigned to the electronic payment card upon verifying the connectivity request; and (2) receive a merchant information of the merchant associated with the merchant networking device, the merchant information comprising at least a merchant identifier and details of an acquirer account of the merchant. The processing system in operative communication with the communication module is configured to: (1) generate a payment transaction request for a payment transaction to the merchant networking device upon receiving the merchant information, the payment transaction request comprising at least a payment card information of the electronic payment card of the cardholder and a transaction amount to be paid to the acquirer account from an issuer account of the cardholder.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, in which at least some example embodiments of the present disclosure can be implemented;

FIG. 2 illustrates a simplified representation of electronic payment card, in accordance with an example embodiment;

FIG. 3A illustrates a sequence flow diagram representing a method for pairing an electronic payment card with a merchant networking device, in accordance with an example embodiment;

FIG. 3B illustrates a sequence flow diagram representing a method for performing a payment transaction at a merchant facility with the electronic payment card of FIG. 2, in accordance with an example embodiment;

FIG. 3C illustrates a sequence flow diagram representing a method for performing a payment transaction at a merchant facility with the electronic payment card of FIG. 2, in accordance with another example embodiment;

FIG. 4A illustrates an example representation of a UI displayed to a cardholder on a display module of the electronic payment card of FIG. 2 depicting a plurality of merchant networking devices in a vicinity of the cardholder for performing a payment transaction, in accordance with an example embodiment;

FIG. 4B illustrates an example representation of a UI displayed to a cardholder on a display module of the electronic payment card of FIG. 2 for verifying connectivity request of the cardholder with a merchant networking device for performing a payment transaction, in accordance with an example embodiment;

FIG. 4C illustrates an example representation of a UI displayed to a cardholder on a display module of the electronic payment card of FIG. 2 depicting the cardholder providing a password for connecting with the merchant networking device for performing a payment transaction, in accordance with an example embodiment;

FIG. 4D illustrates an example representation of a UI displayed to a cardholder on a display module of the electronic payment card of FIG. 2 depicting pushing of payment related information associated with the merchant for performing a payment transaction, in accordance with an example embodiment;

FIG. 5A illustrates an example representation of a UI displayed to a cardholder on a display module of the electronic payment card of FIG. 2 depicting the cardholder providing a payment amount for performing a payment transaction, in accordance with an example embodiment;

FIG. 5B illustrates an example representation of a UI displayed to a cardholder on a display module of the electronic payment card of FIG. 2 depicting the cardholder providing authentication data for authenticating a payment transaction, in accordance with an example embodiment;

FIG. 5C illustrates an example representation of a UI displayed to a cardholder on a display module of the electronic payment card of FIG. 2 depicting a status of the payment transaction performed via the merchant networking device, in accordance with an example embodiment;

FIG. 6 illustrates an example representation of a UI displayed to a cardholder on a display module of the electronic payment card of FIG. 2 depicting a past transaction history using the electronic payment card, in accordance with an example embodiment;

FIG. 7 illustrates a flow diagram of a method for performing a payment transaction with an electronic payment card via a merchant networking device, in accordance with an example embodiment;

FIG. 8 is a simplified schematic block diagram of the payment card of FIG. 2, in accordance with an example embodiment;

FIG. 9 is a simplified schematic block diagram of the merchant networking device, in accordance with an example embodiment;

FIG. 10 is a simplified block diagram of a server system used for processing a payment transaction performed with the electronic payment card of FIG. 2 via the merchant networking device, in accordance with one embodiment of the present disclosure;

FIG. 11 is a simplified block diagram of an issuer server for processing a payment transaction performed with the electronic payment card of FIG. 2 via the merchant networking device, in accordance with one embodiment of the present disclosure;

FIG. 12 is a simplified block diagram of an acquirer server for processing a payment transaction performed with the electronic payment card of FIG. 2 via the merchant networking device, in accordance with one embodiment of the present disclosure; and

FIG. 13 is a simplified block diagram of a payment server used for processing a payment transaction performed with the electronic payment card of FIG. 2 via the merchant networking device, in accordance with one embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “issuer account” used herein refers to a financial account that is used to fund the financial transaction (interchangeably referred to as “payment transaction”). Further, the term “acquirer account” used herein refers to a financial account of a merchant or any entity which receives the fund from the issuer account. Examples of the issuer account and the acquirer account include, but are not limited to a savings account, a credit account, a checking account, digital wallet, and a virtual payment account. Each of the issuer account and the acquirer account may be associated with an entity such as an individual person, a family, a commercial entity, a company, a corporation, a governmental entity, a non-profit organization and the like. In some scenarios, an issuer or acquirer account may be a virtual or temporary payment account that can be mapped or linked to a primary payment account, such as those accounts managed by PayPal®, and the like.

The term “payment card”, used herein, refers to a physical or virtual card linked with a financial or payment account that may be presented to a merchant or any such facility in order to fund a financial transaction via the associated payment account. Examples of the payment card include, but are not limited to, debit cards, credit cards, prepaid cards, digital wallet, virtual payment numbers, virtual card numbers, forex card, charge cards and stored-value cards. A payment card may be a physical card that may be presented to the merchant for funding the payment. Alternatively or additionally, the payment card may be embodied in form of data stored in a user device, where the data is associated with payment account such that the data can be used to process the financial transaction between the payment account and a merchant's financial account.

The term “payment network”, used herein, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by Mastercard®, VISA®, Discover®, American Express®, etc.

### OVERVIEW

In an example scenario, a cardholder may intend to pay for goods/services purchased at a merchant facility using a payment card. The merchant facility may be a physical store where users visit for purchasing goods/services. The cardholder can connect to a merchant networking device via his/her payment card. The payment card is an electronic payment card adapted to connect to the merchant networking device wirelessly for performing financial transactions. Various embodiments of the present disclosure provide methods and systems for performing payment transactions at the merchant facility using the electronic payment card. More specifically, embodiments provide techniques to initiate payment transactions with the electronic payment card via the merchant networking device without directly using a POS terminal.

Various example embodiments provide methods, systems, and computer program products for connecting the electronic payment card with the merchant networking device to perform payment transactions. The cardholder may power ON the electronic payment card and send a connectivity request to the merchant networking device. For example, the electronic payment card may display a list of merchant networking devices associated with different merchants in the vicinity. The cardholder may select the merchant networking device associated with the merchant facility to whom he intends to pay for the goods/services purchased on his/her electronic payment card, for sending the connectivity request. The merchant networking device may verify the connectivity request and facilitate pairing of the electronic payment card with the merchant networking device. The merchant networking device may assign a device identifier for the electronic payment card for identifying the cardholder associated with the electronic payment card among a plurality of cardholders performing payment transactions with the merchant.

In at least one example embodiment, the merchant networking device may push payment related information to the electronic payment card upon pairing with the electronic payment card. The payment related information may include merchant information such as, merchant name, merchant identifier, merchant account information. In some example embodiments, the merchant networking device may share a payment page of the merchant with the electronic payment card. The cardholder keys in a transaction amount and sends a payment transaction request. The payment transaction request includes at least a payment card information of the electronic payment card of the cardholder and a transaction amount to be paid to an acquirer account of the merchant from an issuer account of the cardholder. Further, the cardholder may authenticate the payment transaction while sending the payment transaction request. For example, the cardholder may provide a Personal Identification Number (PIN) for authenticating the payment transaction.

The merchant networking device sends the payment transaction request to a server system associated with a payment network for facilitating the payment transaction from the issuer account to the acquirer account (also referred to as ‘merchant account’). In some example embodiments, the merchant networking device is configured to send a merchant device identifier associated with the merchant networking device to the server system along with the payment transaction request. The merchant device identifier enables the server system to identify the merchant networking device and route a status of the payment transaction to the merchant networking device upon processing the payment transaction request. In at least one example embodiment, the merchant networking device is configured to set a flag identifier indicating to the server system that the payment transaction has been received from an electronic payment card via the merchant networking device. The server system facilitates processing the payment transaction request for facilitating the payment transaction between an issuer account of the cardholder and an acquirer account (or the merchant account) of the merchant.

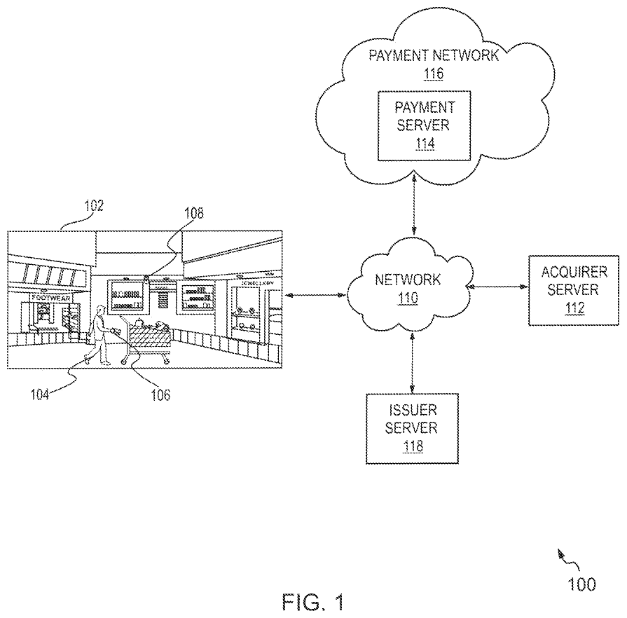

Various example embodiments of present invention are described hereinafter with reference to FIGS. 1 to 13.

FIG. 1 illustrates an exemplary representation of an environment 100, in which at least some example embodiments of the present disclosure can be implemented. The environment 100 is exemplarily shown as a merchant facility 102 (also referred to herein as ‘a merchant 102’). Examples of the merchant facility 102 may include any retail establishments such as, restaurant, supermarket or business establishments such as, government and/or private agencies, toll gates, parking lot where users visit for performing financial transaction in exchange for any goods and/or services or any transaction that requires financial transaction between users and a merchant. The merchant facility 102 is equipped with a merchant networking device 108 connected to an Internet Service Provider. The merchant networking device 108 is a networking device that facilitates access to Internet provided by the Internet Service Provider via a Wireless Local Area Network (WLAN). In some example embodiments, the merchant networking device 108 is a wireless access point providing Internet services that may be managed by the merchant facility 102. It shall be noted that herein the merchant networking device 108 refers to a Wireless Fidelity (WiFi) router that is configured to route data packets within a network 110/payment network 116.

In various embodiments, the merchant networking device 108 facilitates payment transactions of a user, for example, a cardholder 104. In an example scenario, the cardholder 104 may purchase goods from the merchant 102 and intends to pay for the goods using a payment card 106. The payment card 106 (also referred to as ‘an electronic payment card 106’) is an electronic payment card that may be used to initiate a payment transaction without the need to swipe the payment card 106 at a POS terminal.

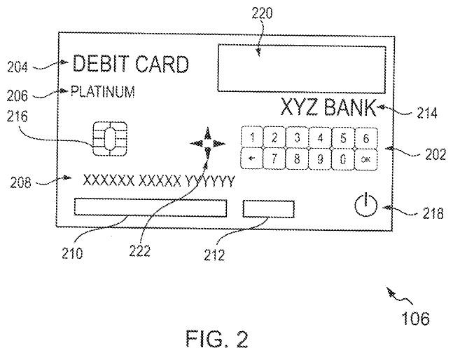

Referring now to FIG. 2, an electronic payment card 106 including a key pad 202 among other components is shown in accordance with an example embodiment. The key pad 202 (also referred to as ‘a number pad 202’) as shown in FIG. 2 is a numeric keypad and the keys are arranged in two rows. The first row of keys comprises the numbers 1 to 6 and the second row of keys comprises the numbers 7 to 9 and 0. Further, the rightmost key in the second row is depicted as a key associated with text ‘ok’ and the leftmost key in the second row is depicted as a ‘backspace’ key. The number pad 202, as an example, can be an electronic keypad comprising a control circuitry that converts key presses into codes. Examples of electronic keypads include optical keypads or capacitive keypads. The number pad 202 can also be a mechanical keypad. The keypad input information is stored in a storage chip 216 present in the payment card 106.

The electronic payment card 106 includes information such as type of card (e.g., credit/debit) 204, type of cardholder membership (e.g., platinum/gold, etc.) 206, card number 208, name of the cardholder 210, expiry date of the payment card 212, name of issuing bank 214 printed on one surface (shown in FIG. 2) of the payment card 106. The number pad 202 and the storage chip 216 are also provisioned on the surface of the payment card 106 where the printed information appears. The other surface of the electronic payment card 106 which is not shown in FIG. 2 includes information such as a Card Verification Value (CVV) number and other information as may be already known in the art. The electronic payment card 106 includes a display 220 that displays the keypad inputs provided by the cardholder 104. The storage chip 216 stores information corresponding to the electronic payment card 106 and the cardholder 104. Additionally, the electronic payment card 106 is configured to store payment history associated with the electronic payment card 106, for example, transaction details and status of the transaction. For example, past 5 transactions performed by the cardholder 104 may be stored in the storage chip 216 and can be viewed by the cardholder 104 on the display 220.

The storage chip 216 further stores instructions which may correspond to powering ON and powering OFF of the payment card 106, reading of keypad inputs, storing of keypad inputs, erasing of keypad inputs and transferring of keypad inputs to a connected device, and connecting with remote devices such as, the merchant networking device 108. As an example, the storage chip 216 may include instructions to connect with other remote devices, for example, the merchant networking device 108 for performing payment transactions. It may be noted that upon transfer of the keypad inputs to a server system via a payment network 116, the keypad inputs may be erased from the storage chip 216.

The electronic payment card 106 may be provisioned with a power supply unit, such as a battery unit or a capacitor and a corresponding power button 218 for powering the number pad 202. The power button 218 is an example of an electronic or a mechanical key similar to the other keys arranged in the number pad 202. The electronic payment card 106 also includes navigation keys 222 for navigating between fields on the display 220. The thickness of the power button 218 is same as the thickness of the keypad and conforms to the standard overall thickness of the electronic payment card 106. As an example, the electronic payment card 106 may be so configured that pressing the power button 218 once, for a predefined duration activates the electronic payment card 106 and pressing the power button 218 twice for a predefined duration deactivates or turns OFF the electronic payment card 106.

In yet another embodiment, the electronic payment card 106 may be implemented without the power button 218. Such electronic payment card 106 may be so configured that when the electronic payment card 106 is inserted into a card reader device at a POS terminal, the electrical components of the electronic payment card 106 are powered ON and a communication module transfers the information in the storage chip 216 to the POS terminal.

In at least one example embodiment, the electronic payment card 106 includes a transceiver (not shown in FIG. 2) for communicating with access points providing Internet services to share/communicate information related to payment transaction for performing payment transactions. In an example, the electronic payment card 106 may communicate with the merchant networking device 108 providing Internet services for performing the payment transaction.

Referring again to FIG. 1, in a scenario where a payment card (such as the electronic payment card 106) is powered ON by the cardholder 104, the electronic payment card 106 is activated and can initiate payment transactions. The electronic payment card 106 may display one or more merchant networking devices associated with one or more merchants providing Internet services for their users, for example, the cardholder 104 in the vicinity. The cardholder 104 may select a merchant networking device (e.g., the merchant networking device 108) among the one or more merchant networking devices based on the merchant 102 he/she intends to pay for the goods/services purchased. When the cardholder 104 selects the merchant networking device 108 among the one or more merchant networking devices, a connectivity request is sent to the merchant networking device 108. In some example embodiments, the cardholder 104 may have to provide credentials, such as a password for pairing with the merchant networking device 108 so as to access the Internet services provided by the merchant networking device 108. For instance, in a non-limiting example, a fixed character length password or a fixed character length one time password (OTP) may be displayed at the merchant facility 102 so as to enable the users to pay for goods/services via their respective merchant networking devices. The merchant networking device 108 is configured to verify the credentials, and upon verification, the merchant networking device 108 and the electronic payment card 106 are paired together. It shall be noted that the electronic payment card 106 and the merchant networking device 108 may be paired together on receipt of the connectivity request at the merchant networking device 108 without the cardholder 104 providing any credential for verifying the connectivity request.

In some example embodiments, the merchant networking device 108 assigns a device identifier (also referred to as ‘a local identifier’) for the electronic payment card 106 upon pairing with the merchant networking device 108. More specifically, the merchant networking device 108 assigns an IP address to the electronic payment card 106 so as to identify the electronic payment card 106 of the cardholder 104 among a pool of cardholders performing payment transactions via the merchant networking device 108. The assigning of the device identifier ensures that no two electronic payment cards have the same IP address while connecting with the merchant networking device 108. The device identifier of the electronic payment card 106 is stored in a memory of the merchant networking device for a predefined duration so as to ensure that the cardholder 104 does not have to send a connectivity request to pair the electronic payment card 106 with the merchant networking device 108. For example, the predefined duration may be 2 hours for retaining the device identifier of the electronic payment card 106 as the cardholder 104 may on an average spends 2 hours at the merchant facility 102 (e.g., a supermarket). The cardholder 104 may make multiple purchases within that 2 hours duration and the cardholder 104 may not have to pair the payment card 106 with the merchant networking device 108 for each payment transaction.

In some example embodiments, the merchant networking device 108 shares payment related information with the electronic payment card 106 for performing the payment transaction. In an example, the merchant networking device 108 may be configured to route/redirect cardholders pairing with the merchant networking device 108 to a default page, for example, a payment page for performing payment transactions to the merchant using the electronic payment card 106. Accordingly, each merchant facility (e.g., the merchant facility 102) may have to create merchant specific Uniform Resource Locator (URL) that includes payment related information for corresponding merchant. Moreover, merchant facilities must configure their respective merchant networking device (e.g., the merchant networking device 108) to redirect to the merchant specific URL for processing the payment transaction. In an example, when the cardholder 104 pairs with the merchant networking device 108, the merchant networking device 108 shares the payment related information of the merchant 102 as the payment page with the electronic payment card 106 of the cardholder 104. The cardholder 104 may enter a transaction amount for the goods/services purchased and initiate the payment transaction using the payment card 106 via the merchant networking device 108. The electronic payment card 106 sends a payment transaction request to the merchant networking device 108 for processing the payment transaction. The payment transaction request includes a payment card information of the electronic payment card 106 of the cardholder 104, a transaction amount to be paid to a merchant account of the merchant 102 from an issuer account of the cardholder 104 and a merchant device identifier associated with the merchant networking device 108. The merchant device identifier is used to identify the merchant networking device so as to share a status of the payment transaction associated with the electronic payment card 106.

In some example embodiments, the cardholder 104 may authenticate the payment transaction while initiating the payment transaction. The cardholder 104 may provide a fixed length password or One Time Password (OTP) to authenticate the payment transaction. The merchant networking device 108 is configured to modify and set a flag identifier indicating that the payment transaction has been initiated by the electronic payment card 106 and sent via the merchant networking device 108. The merchant networking device 108 sends the payment transaction request to the acquirer server 112 via a network 110. The acquirer server 112 forwards the payment transaction request to a payment server 114 via a payment network 116. The payment server 114 forwards the payment transaction request to an issuer server 118. Upon verification by the issuer server 118, the payment server 114 settles the transaction between the issuer server 118 and an acquirer server 112 via the payment network 116 by transferring the transaction amount from the issuer account of the cardholder 104 to the merchant account of the merchant 102. Examples of the payment network 116 include, but not limited to, Mastercard® payment system interchange network 116. The Mastercard® payment system interchange network 116 is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.). The payment card system interchange network 116 is hereinafter referred to as the payment network 116.

The issuer server 118 sends the status of the payment transaction to the merchant networking device 108 based on the merchant device identifier. The merchant networking device 108 in turn shares the status of the payment transaction with the electronic payment card 106 based on the device identifier of the electronic payment card 106.

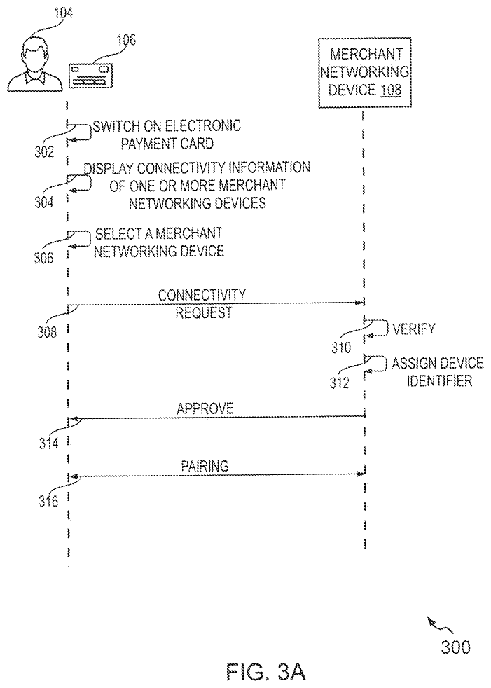

Some non-exhaustive example embodiments of performing payment transactions using the electronic payment card 106 at the merchant facility 102 via the merchant networking device 108 are described with reference to FIGS. 3A-3C to 7.

Referring now to FIG. 3A, a sequence flow diagram 300 representing a method for pairing the electronic payment card 106 with the merchant networking device 108 is illustrated in accordance with an example embodiment.

At 302, the cardholder 104 powers ON the electronic payment card 106. The cardholder 104 may press the power button 218 (shown in FIG. 2) so as to activate the electronic payment card 106. At 304, the electronic payment card 106 displays connectivity information of one or more merchant networking devices in the vicinity of the cardholder 104. The display module 220 may display a list of merchant networking devices associated with merchants in a vicinity of the cardholder 104. For example, if the cardholder 104 visits a café store (Café Zone) at a shopping mall and powers on the electronic payment card 106, the display 220 of the electronic payment card 106 displays merchant networking devices (A1, B1, C1) associated with merchants (Dress Maker, Kids Joy, Café Zone), respectively.

At 306, the cardholder 104 selects a merchant networking device (e.g., the merchant networking device C1) from the one or more merchant networking devices. In an example, the cardholder 104 may have enjoyed snacks/coffee at the Café Zone and accordingly intends to pay the merchant (Café Zone). The cardholder 104 selects the merchant networking device C1 among the merchant networking devices (A1, B1, C1) by providing a selection input on the merchant networking device C1.

At 308, the electronic payment card 106 sends a connectivity request to the merchant networking device 108. When the cardholder 104 selects the merchant networking device C1, the connectivity request is sent from the electronic payment card 300 to the merchant networking device C1.

At 310, the merchant networking device C1 verifies the connectivity request received from the electronic payment card 106. In some example embodiments, the merchant networking device C1 may display a prompt on the electronic payment card 106 requesting the cardholder 104 to provide a password. When the cardholder 104 provides the password (static/dynamic password), the merchant networking device C1 verifies the connectivity request. Alternatively, if there exists no password for accessing services of the merchant networking device C1, the merchant networking device C1 checks if the electronic payment card 106 is in a vicinity of the merchant (Café Zone) and has required resources/compatibility to perform payment transactions for verifying the connectivity request.

At 312, the merchant networking device C1 assigns a device identifier for the electronic payment card 106. Upon verifying the connectivity request, the merchant networking device C1 assigns the device identifier (e.g., 102. 11. 198) for the electronic payment card 106 so as to identify the electronic payment card 106 among a pool of electronic payment cards paired with the merchant networking device C1 for performing payment transactions. More specifically, the device identifier is an IP address assigned to the electronic payment card 106 for routing/redirecting status of the payment transaction from the merchant networking device C1. The merchant networking device C1 stores the device identifier of the electronic payment card along with payment related information of the electronic payment card 106 initiated at the merchant networking device C1 for further processing.

At 314, the merchant networking device C1 approves the connectivity request and sends an acknowledgement/notification to the electronic payment card 106. At 316, the merchant networking device C1 and the electronic payment card 106 are paired with each other. The pairing of the electronic payment card 106 with the merchant networking device C1 ensures that the electronic payment card 106 and the merchant networking device C1 communicate with each other to share information. More specifically, the merchant networking device acts as an access point for availing Internet services and more like a payment gateway to process the payment transaction.

Referring now to FIG. 3B, a sequence flow diagram 320 representing a method for performing a payment transaction at a merchant facility with the electronic payment card 106 of FIG. 2 is illustrated, in accordance with an example embodiment.

At 322, a connectivity request is sent from the electronic payment card 106 to the merchant networking device 108 (merchant networking device C1). At 324, the merchant networking device 108 verifies the connectivity request of the electronic payment card 106. At 326, the merchant networking device 108 approves the connectivity request of the electronic payment card 106. The merchant networking device assigns a device identifier for the electronic payment card 106.

At 328, the merchant networking device 108 (also referred to as ‘merchant networking device C1’) pushes payment related information to the electronic payment card 106. In some example embodiments, the merchant networking device C1 of the merchant (Café Zone) may be configured to redirect cardholders pairing with the merchant networking device C1 to a merchant specific URL of the merchant (Café Zone) for performing payment transactions. The merchant specific URL may be a payment page including payment related information for processing the payment transaction.

At 330, the cardholder 104 keys in a transaction amount for the goods/services purchased at the merchant facility 102 in the electronic payment card 106. It shall be noted that the payment page may request/prompt the cardholder 104 to provide more information related to the payment transaction and the transaction amount has been described for exemplary purposes only.

At 332, the cardholder 104 provides a PIN for authenticating the payment transaction initiated via the electronic payment card 106. At 334, the electronic payment card 106 sends a payment transaction request to the merchant networking device 108. The payment transaction request includes a payment card information of the electronic payment card 106 of the cardholder, the transaction amount to be paid to a merchant account from an issuer account of the cardholder 104, and a device identifier of the electronic payment card 106.

At 336, the merchant networking device 108 modifies a flag identifier. The flag identifier is set to indicate the one or more server systems associated with the payment network 116 that the payment transaction has been received from the electronic payment card 106 via the merchant networking device 108.

At 338, the merchant networking device 108 forwards the payment transaction request along with the merchant device identifier and the flag identifier to the acquirer server 112. The merchant device identifier is an identifier, more specifically, IP address of the merchant networking device in the payment network 116 for identifying and routing status of payment transactions and payment related information associated with the payment card 106. At 340, the acquirer server 112 forwards the payment transaction request along with the merchant device identifier and the flag identifier to the payment server 114. At 342, the payment server 114 forwards the payment transaction request along with the merchant device identifier and the flag identifier to the issuer server 118.

At 344, the issuer server 118 verifies the payment transaction request. For instance, the issuer server 118 verifies whether the PIN provided by the cardholder 104 is a registered PIN associated with account of the cardholder 104 for which the payment card 106 was issued to the cardholder 104. The issuer server 118 further checks the account balance of the issuer account and if the account balance is enough to accommodate the transaction amount of the payment transaction. Based on these determinations, a transaction associated with the payment transaction request may be facilitated to debit funds equivalent to the transaction amount from the issuer account and credit the transaction amount to the merchant account of the merchant.

At 346, the issuer server 118 sends a status including a payment transaction approval/decline message of the payment transaction to the payment server 114. At 348, the payment server 114 forwards the status including the payment transaction approval/decline message of the payment transaction to the acquirer server 114. At 350, the acquirer server 112 forwards the status including the payment transaction approval/decline message of the payment transaction to the merchant networking device 108 based on the merchant device identifier. At 352, the merchant networking device 108 forwards the status including the payment transaction approval/decline message of the payment transaction to the electronic payment card 106.

Referring now to FIG. 3C, a sequence flow diagram 360 representing a method for performing a payment transaction at a merchant facility with the electronic payment card of FIG. 2 is illustrated, in accordance with another example embodiment.

At 362, a connectivity request is sent from the electronic payment card 106 to the merchant networking device 108. At 364, the merchant networking device 108 verifies the connectivity request of the electronic payment card 106. At 366, the merchant networking device 108 approves the connectivity request of the electronic payment card 106. At 368, the merchant networking device 108 pushes payment related information to the electronic payment card 106.

At 370, the cardholder 104 keys in a transaction amount for the goods/services purchased at the merchant facility 102 in the electronic payment card 106. At 372, the electronic payment card 106 sends a payment transaction request to the merchant networking device 108.

At 374, the merchant networking device 108 modifies a flag identifier. At 376, the merchant networking device 108 forwards the payment transaction request along with the merchant device identifier and the flag identifier to the acquirer server 112. At 378, the acquirer server 112 forwards the payment transaction request along with the merchant device identifier and the flag identifier to the payment server 114. At 380, the payment server 114 forwards the payment transaction request along with the merchant device identifier and the flag identifier to the issuer server 118.

At 382, the issuer server 118 sends an authentication request to the cardholder 104 on the electronic payment card 106. Upon receiving the payment transaction request, the issuer server 118 may prompt the cardholder 104 to provide the PIN for authenticating the payment transaction via the electronic payment card 106.

At 384, the cardholder 104 provides authentication data in response to the authentication request via the electronic payment card 106 to the issuer server 118. For instance, the cardholder 104 provides the PIN on the electronic payment cad 106 using a number pad (see, number pad 202).

At 386, the issuer server 118 verifies the payment transaction request. At 388, the issuer server 118 sends a status including a payment transaction approval/decline message of the payment transaction to the payment server 114. At 390, the payment server 114 forwards the status including the payment transaction approval/decline message of the payment transaction to the acquirer server 114. At 392, the acquirer server 112 forwards the status including the payment transaction approval/decline message of the payment transaction to the merchant networking device 108 based on the merchant device identifier. At 394, the merchant networking device 108 forwards the status including the payment transaction approval/decline message of the payment transaction to the electronic payment card 106.

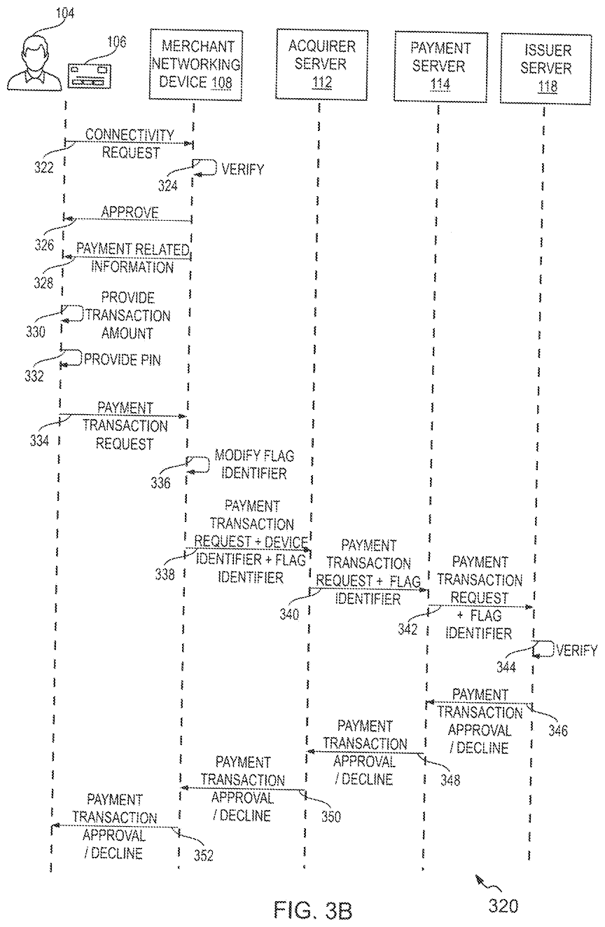

Referring now to FIG. 4A, an example representation of a UI 400 displayed to the cardholder 104 on the display 220 of the electronic payment card 106 of FIG. 2 depicting a plurality of merchant networking devices in a vicinity of the cardholder 104 for performing a payment transaction is illustrated in accordance with an example embodiment. The UI 400 may be displayed to the cardholder 104 upon selection of the option associated with the label ‘MAKE PAYMENT’ (not shown in FIG. 4A) upon powering ON the electronic payment card 106. It is noted that the provisioning of the ‘MAKE PAYMENT’ option is explained herein for illustration purposes and may not be considered as limiting the scope of the disclosure. Alternatively, the UI 400 may be displayed to the cardholder 104 by selection of other options or options with different labels than the labels explained herein.

As seen in FIG. 4A, the display 220 of the electronic payment card 106 lists one or more merchant networking devices (e.g., devices of “merchant 1, merchant 2, merchant 3 and merchant 4”) associated with one or more merchants in the vicinity of the cardholder 104 accepting payments performed via the electronic payment card 106. It shall be noted that each of the merchants (e.g., merchants 1 to 4) configures respective merchant networking device to redirect payment transactions initiated at the respective merchant terminal to a merchant specific URL associated with the merchant networking device. Additionally or optionally, a connectivity strength of each merchant networking device is also displayed beside name of the merchants. The cardholder 104 can select a merchant networking device associated with a merchant to whom the cardholder 104 intends to perform a payment transaction for the goods/services purchased by providing a touch input on the respective merchant networking device (e.g., device of merchant 2) in the display 220. Alternatively, the cardholder 104 may use the navigation keys 222 to select the merchant networking device (e.g., device of merchant 2) among the list of merchant networking devices (e.g., devices of merchants 1 to 4) displayed on the display 220. In an embodiment, when the cardholder 104 selects the merchant networking device (e.g., device of merchant 2), a connectivity request is sent to the merchant networking device (device of merchant 2).

Referring now to FIGS. 4B-4C, example representations of UIs 430&450 displayed to the cardholder 104 on the display 220 of the electronic payment card 106 of FIG. 2 is illustrated, in accordance with an example embodiment. The UIs 430&450 are representative UIs for verifying connectivity request of the cardholder 104 with the merchant networking device 108 for performing a payment transaction. The UI 430 may be displayed to the cardholder 104 upon selection of at least one merchant networking device (e.g., merchant 2) among the list of merchant networking devices (devices of merchants 1 to 4) displayed on the display 220 of the electronic payment card 106.

In some example embodiments, the merchant networking device (merchant 2) may be configured to authenticate the connectivity request of electronic payment card 106 prior to initiating a payment transaction. For example, the merchant networking device (device of merchant 2) may prompt the cardholder 104 to provide a password in a text box 432 (see, FIG. 4B) for connecting with the merchant networking device (merchant 2). The password may be a fixed length static password displayed at the merchant facility 102 or a dynamic password such as, an OTP for securing connection with the merchant networking device (device of merchant 2). The cardholder 104 may provide the password in the textbox 432 via the number pad 202 of the electronic payment card 106 (see, UI 450 shown in FIG. 4C).

Referring now to FIG. 4D, an example representation of a UI 470 displayed to the cardholder 104 on the display 220 of the electronic payment card 106 of FIG. 2 depicting pushing of payment related information associated with the merchant (merchant 2) for performing a payment transaction, is illustrated, in accordance with an example embodiment. The UI 470 may be displayed to the cardholder 104 upon verifying the password provided by the cardholder 104 for verifying the connectivity request to the merchant networking device 108. As shown in the UI 470, the cardholder 104 is notified that the payment related information to the merchant associated with the merchant networking device (merchant 2) selected by the cardholder 104 is being shared and stored in the storage chip 216 of the electronic payment card 106 for initiating the payment transaction to the merchant.

As exemplarily illustrated, the UI 470 displays a text snippet 472 associated with text “STORING . . . merchant 2 data” indicating that the electronic payment card 106 is paired with the merchant networking device (merchant 2) and the cardholder 104 is routed/redirected to a default page (merchant specific URL) created by the merchant associated with the merchant networking device (device of merchant 2) for performing payment transactions to the merchant using the electronic payment card 106.

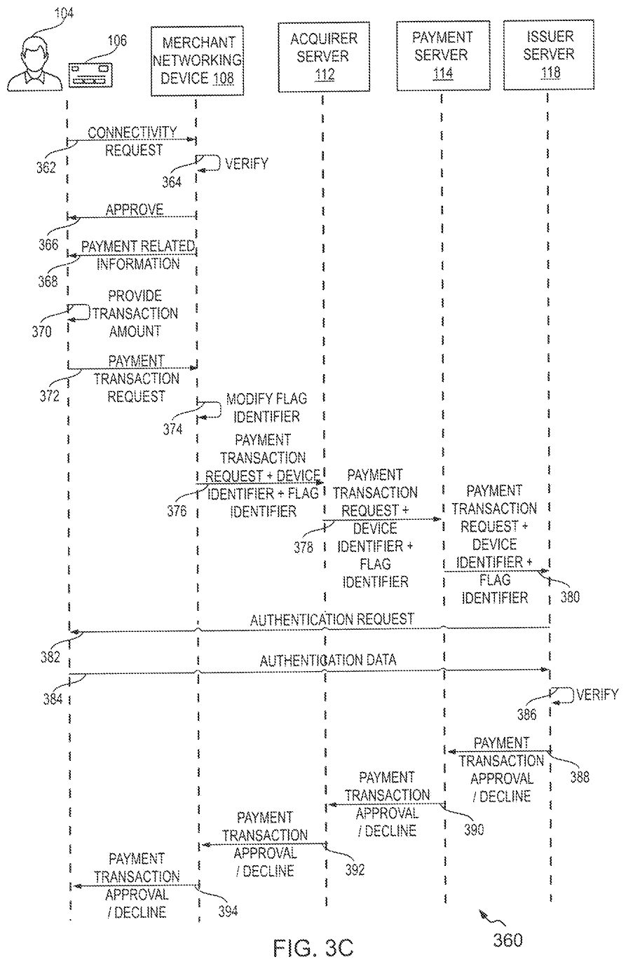

Referring now to FIG. 5A, an example representation of a UI 500 displayed to the cardholder 104 on the display 220 of the electronic payment card 106 of FIG. 2 depicting the cardholder 104 providing a payment amount for performing a payment transaction, is illustrated in accordance with an example embodiment. The UI 500 may be displayed to the cardholder 104 upon pairing with the merchant networking device (device of merchant 2) of the merchant. The UI 500 may include a field 502 for providing transaction amount that has to be debited from an issuer account of the cardholder 104 for crediting to the merchant account of the merchant associated with the merchant networking device (device of merchant 2). The transaction amount refers to a total amount for the goods/services purchased at the merchant. The cardholder 104 provides the transaction amount in the field 502.

It shall be noted that the UI 500 may include fewer or more fields than those depicted in FIG. 5A and transaction amount field has been shown for example purposes only. In some example embodiments, the UI 500 may display a payment page including fields, such as, a merchant identifier, a merchant name, payment card information and transaction amount and the cardholder 104 may scroll the payment page to verify details and provide the transaction amount.

Referring now to FIG. 5B, an example representation of a UI 530 displayed to the cardholder 104 on the display 220 of the electronic payment card 106 of FIG. 2 depicting the cardholder 104 providing authentication data for authenticating a payment transaction is illustrated in accordance with an example embodiment.

In one example embodiment, the UI 530 may be displayed to the cardholder 104 upon initiating a payment transaction request to the merchant via the merchant networking device (device of merchant 2). For instance, when the cardholder 104 keys in the transaction amount in the payment page and initiates the payment transaction, a prompt to provide authentication data in a text box 532 for authenticating the payment transaction is displayed to the cardholder 104. In another example embodiment, an issuer server (e.g., the issuer server 118) associated with the electronic payment card 106 may receive the payment transaction request, and, in response, may request authentication data from the cardholder 104 using the electronic payment card 106 for performing the payment transaction. In either ways, the user keys in a fixed length password (also referred to as ‘PIN’) as the authentication data for authenticating the payment transaction (see, text box 532). As seen in FIG. 5B, the cardholder 104 provides PIN “5234” for authenticating the payment transaction. The authentication data is verified by the issuer server 118 before debiting the transaction amount from the issuer account of the cardholder 104.

Referring now to FIG. 5C, an example representation of a UI 550 displayed to the cardholder 104 on the display 220 of the electronic payment card 106 of FIG. 2 depicting a status of the payment transaction performed via the merchant networking device 108 is illustrated in accordance with an example embodiment. The UI 550 is displayed on the electronic payment card 106 upon verifying the authentication data provided by the cardholder 104.

In an example, the issuer server 118 may check a balance amount to determine if the balance amount is sufficient to fund the transaction amount for the payment transaction and also verify credentials such as, authentication data before processing the payment transaction. The issuer server 118 then updates and sends the status of the payment transaction to other server systems (i.e. the payment server 114, the acquirer server 112) in the payment network 116. As shown in FIG. 5C, the status is a message 552 associated with text “PAYMENT SUCCESSFUL” indicating that the payment transaction has been approved by the issuer server 118 and has been successfully processed.

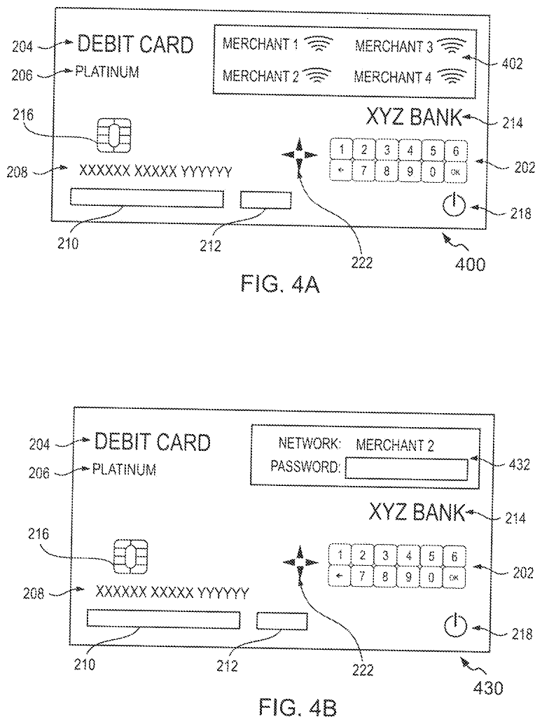

Referring now to FIG. 6, an example representation of a UI 600 displayed to the cardholder 104 on the display 220 of the electronic payment card 106 of FIG. 2 depicting a past transaction history using the electronic payment card 106, is illustrated in accordance with an example embodiment. The UI 600 may be displayed to the cardholder 104 upon selection of the option associated with a label ‘TRANSACTION HISTORY’ (not shown in FIG. 6) upon powering ON the electronic payment card 106. It is noted that the provisioning of the ‘TRANSACTION HISTORY’ option is explained herein for illustration purposes, and alternatively the UI 600 may be displayed to the cardholder 104 by selection of other options or options with different labels than the labels explained herein.

As seen in FIG. 6, the display 220 of the electronic payment card 106 displays the transaction history 602 of the payment card 106 as a list of past pre-defined number of transactions such as 5 transactions. In an example, the transaction history includes a day of the transaction, a name of the merchant facility, a transaction amount and a status of the transaction. As shown in UI 600, the recent transaction using the electronic payment card 106 was performed on “16 Jul. 2018” at “Café Zone” for a transaction amount of “$20” and the payment transaction was “Approved”. It shall be noted that the display 220 shows only past 2 transactions for exemplary purposes and the cardholder 104 may view remaining transactions by scrolling down using the navigation keys 222 or providing touch inputs on the display 220.

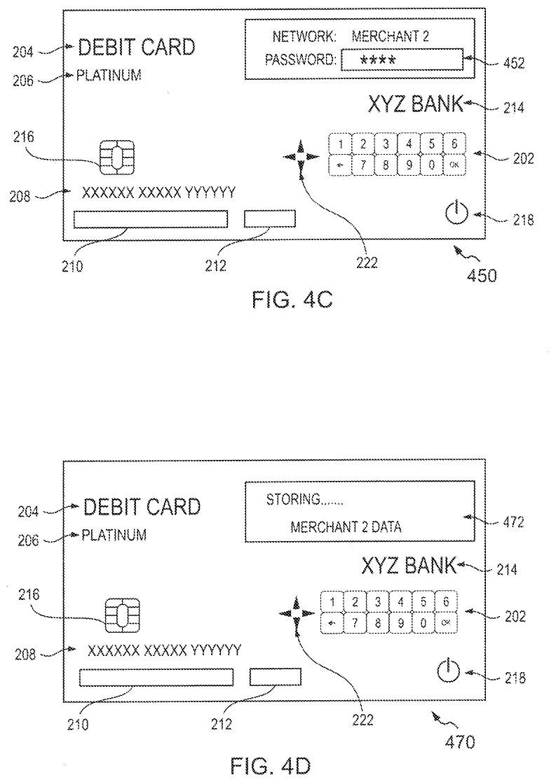

FIG. 7 illustrates a flow diagram of a method 700 for performing a payment transaction with an electronic payment card via a merchant networking device, in accordance with an example embodiment. The method 700 depicted in the flow diagram may be executed by, for example, the merchant networking device 108 or a server system. Operations of the flow diagram, and combinations of operation in the flow diagram, may be implemented by, for example, hardware, firmware, a processor, circuitry and/or a different device associated with the execution of software that includes one or more computer program instructions. The operations of the method 700 are described herein with help of the merchant networking device 108. It is noted that the operations of the method 700 can be described and/or practiced by using a system other than the merchant networking device 108. The method 700 starts at operation 702.

At operation 702, the method 700 includes receiving a connectivity request from an electronic payment card associated with a cardholder at a merchant networking device associated with a merchant. The cardholder may visit a merchant terminal for purchasing goods/services. When the cardholder intends to checkout, he/she can pay using the electronic payment card capable of performing payment transactions via the merchant networking device installed at the merchant facility. The cardholder powers ON the electronic payment card and views the merchant networking devices in vicinity of the electronic payment card. The electronic payment card displays the merchant networking devices (D1, D2, D3, D4) associated with merchants (M1, M2, M3). It shall be noted that each merchant may be associated with one or more merchant networking devices. In an example, the merchant M1 is associated with the merchant networking device D1, the merchant M2 is associated with the merchant networking device D2 and the merchant M3 is associated with the merchant networking devices D3, D4, respectively. Accordingly, if the cardholder intends to pay a merchant, he/she must connect with a respective merchant networking device. For instance, if the cardholder intends to pay merchant M3, he may connect to the merchant networking device D3/D4 for initiating the payment transaction. The cardholder can provide a selection input on the merchant networking device displayed on the display (see, UI 400) of the electronic payment card. When the cardholder selects a merchant networking device (say, merchant networking device D3 associated with merchant M3), a connectivity request is sent to the merchant networking device D3. Additionally or optionally, the cardholder may have to provide a password to verify the connectivity request sent to the merchant networking device.

At operation 704, the method 700 includes facilitating pairing of the electronic payment card with the merchant networking device. Upon receiving the connectivity request, the merchant networking device D3 may verify/authenticate the connectivity request and upon verification may facilitate pairing of the electronic payment card. In an embodiment, the merchant networking device D3 assigns a device identifier for the electronic payment card so as to identify the electronic payment card among a pool of electronic payment cards paired with the merchant networking device D3 for performing payment transactions. The device identifier is more like an IP address assigned to the electronic payment card to route/redirect authorization requests and/or status of payment transactions performed by the cardholder using the electronic payment card via the merchant networking device D3.

At operation 706, the method 700 includes upon pairing, pushing payment related information of the merchant to the electronic payment card. For instance, the merchant networking device may be configured to route/redirect cardholders pairing with the merchant networking device D3 to a payment page of the merchant M3 for performing payment transactions to the merchant M3 using the electronic payment card. Accordingly, each merchant facility (e.g., merchants M1, M2, M3) may have to create merchant specific Uniform Resource Locator (URL), and the corresponding merchant networking devices redirect/route the cardholder to perform the payment transaction based on payment related information for corresponding merchant. For example, merchant M3 may configure an URL (www.abcM3xx.com/payment) so as to receive payment transaction from the cardholders. Whenever, the cardholder connects with the merchant networking device D3/D4, the cardholder is redirected to the URL (www.abcM3xx.com/payment) for processing the payment transaction. The cardholder is required to fill in data fields in the URL for processing the payment transaction. In an example, the URL may already have merchant related information such as, merchant name, merchant identifier, payment card information of the cardholder and a transaction amount field for the cardholder to provide the transaction amount that needs to be credited to the merchant M3.

At operation 708, the method 700 includes receiving a payment transaction request for a payment transaction from the electronic payment card at the merchant networking device. The payment transaction request includes at least a payment card information of the electronic payment card of the user/cardholder and a transaction amount to be paid to a merchant account from an issuer account of the cardholder. When the cardholder provides the transaction amount, or any other data requested by the merchant specific URL (www.abcM3xx.com/payment), the electronic payment card sends the payment transaction request to the merchant networking device. Additionally, or optionally, the device identifier associated with the electronic payment card is also sent along with the payment transaction request. Alternatively, the merchant networking device D3 may automatically identify the payment transaction request from the electronic payment card and store it with a reference identifier in a storage space.

At operation 710, the method 700 includes facilitating processing of the payment transaction based on the payment transaction request. In some example embodiments, the merchant networking device modifies a flag identifier indicating that the payment transaction request has been received from the electronic payment card at the merchant facility (e.g., merchant M3) via the merchant networking device D3. The payment transaction request along with the flag identifier and a merchant device identifier are sent to the server system for further processing of the payment transaction. The merchant device identifier refers to an IP address of the merchant networking device D3 that may be used to identify and route messages such as, status of payment transactions.

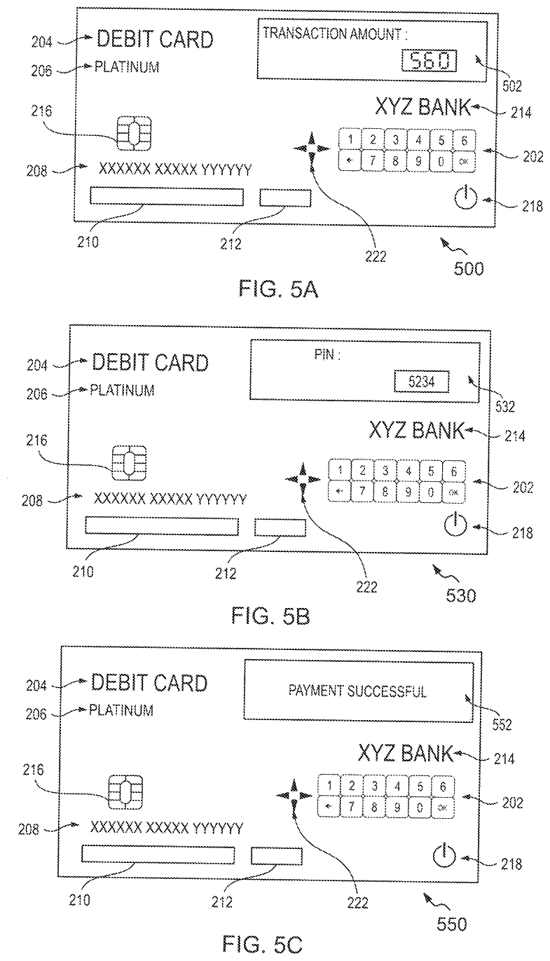

FIG. 8 is a simplified schematic representation 800 of a block diagram of the payment card 106 of FIG. 2, in accordance with an example embodiment. As shown in FIG. 8, the payment card 106 can support one or more input devices 802. Examples of the input devices 802 may include, but are not limited to, a touchpad 804 and a keypad/number pad 806 (such as the number pad 202 in FIG. 2). The keypad 806 can be an electronic keypad comprising a control circuitry that converts key presses into codes. The keypad 806 can also be a mechanical keypad. Examples of electronic keypads include optical keypads or capacitive keypads.

The representation 800 of the payment card 106 depicts a storage component or a memory component 810. Examples of the storage component 810 may include a non-removable memory and/or removable memory. The non-removable memory can include RAM, ROM, flash memory, or other well-known memory storage technologies. The removable memory can include flash memory and smart cards. In this example, the storage component 810 is a chip (Integrated Circuit) based storage/memory. Apart from keypad input data, cardholder information and card information (e.g., type of card, type of cardholder's membership, card number, name of the cardholder, cardholder's account number, PIN, expiry date of the payment card, name of issuing bank, etc.) are also stored in the storage component 810. The storage component 810 also stores transaction history of the payment card 106. The transaction history may include a day of transaction, name of the merchant facility, transaction amount and status of the payment transaction. The storage component 810 may also be used for storing data and/or instructions such as instructions 812.

The instructions 812 are executable by a processing system 814 to enable the storage component 810 to read a keypad press, to store a keypad input, to transfer or write a keypad input to another device, etc. The processing system 814 can be a signal processor, microprocessor, ASIC, or other control and processing logic circuitry for performing such tasks as signal coding, data processing, input/output processing, power control, and/or other functions. The processing system 814 may be configured to perform processing of the keypad input. In another embodiment, a processing system such as the processing system 814 may not be provisioned within the payment card 106. The storage component 810 may be configured with the instructions 812 and the processing capabilities.

The payment card 106 includes a power supply 816 which comprises a thin battery or a capacitor used to power the input devices 802 and optionally some of the other card electrical components such as the processing system 814 of the payment card 106. In an alternate embodiment, the payment card 106 may or may not need a battery, wherein the payment card 106 is configured to be powered when inserted into a terminal such as a POS card reader device.

A communication module 818 can be coupled to one or more antennas (not shown in the FIG. 8) and can support two-way communications between the processing system 814 and external devices, as is well understood in the art. The communication module 818 is shown generically and can be configured with wireless communication modules that enable transfer of data from the payment card 300 to the merchant terminal 104 over short ranges/distances. Examples of the communication module 818 include Bluetooth 820, WiFi 822 (e.g., a WiFi receiver and transmitter), Near Field Communication (NFC) 824, etc.

A display module 826 is a thin flat panel display that employs light modulating properties of liquid crystals. An example of the display module 826 may be a Liquid Crystal Display (LCD) 828. The LCD 828 consumes much less power than Light Emitting Diode displays and are also much thinner so as to be easily integrated into the payment card 106. Further, the display module 826 may include components, such as but not limited to, a touch screen (e.g., capable of capturing finger tap inputs, finger gesture inputs, multi-finger tap inputs, multi-finger gesture inputs, or keystroke inputs from a virtual keyboard or keypad).

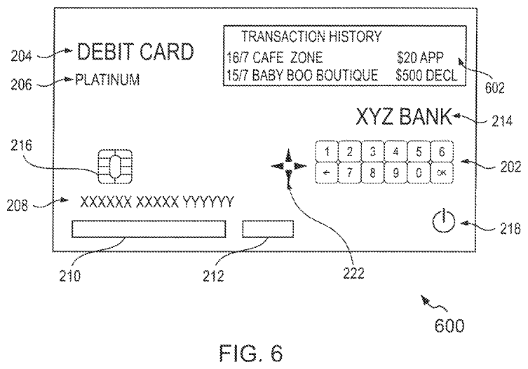

FIG. 9 is a simplified schematic block diagram of the merchant networking device 900, in accordance with an example embodiment. The merchant networking device 108 is an example of the merchant networking device 108 shown in FIG. 1. The merchant networking device 900 includes at least one processor such as a processor 902, a plurality of storage locations (such as a memory 904), an input/output module 906 and a communication interface 908.

Although the merchant networking device 900 is depicted to include only one processor 902, the merchant networking device 900 may include more number of processors therein. In an embodiment, the memory 904 is capable of storing instructions 905 that are machine executable instructions for routing data packets received from remote devices, for example, the electronic payment card 106 to another merchant networking device and/or a server system associated with the payment network 116. In an embodiment, the processor 902 may be embodied as a multi-core processor, a single core processor, or a combination of one or more multi-core processors and one or more single core processors. For example, the processor 902 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, and the like. In an embodiment, the processor 902 may be configured to execute hard-coded functionality. In an embodiment, the processor 902 may be embodied as an executor of software instructions, wherein the software instructions may specifically configure the processor 902 to perform algorithms and/or operations described herein when the software instructions are executed.

The storage locations of the memory 904 may be embodied as one or more volatile memory devices, one or more non-volatile memory devices, and/or a combination of one or more volatile memory devices and non-volatile memory devices. For example, the storage locations of the memory 904 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash ROM, RAM (random access memory), etc.). The memory 904 is configured to manage a table that stores device identifiers associated with electronic payment cards that are paired with the merchant networking device 900 for performing payment transactions to a merchant hosting and managing the merchant networking device 900.

The input/output module 906 (hereinafter referred to as I/O module 906) is configured to facilitate provisioning of an output and/or receiving an input. The I/O module 906 is configured to be in communication with processor 902 and memory 904. Examples of the I/O module 906 include, but are not limited to, an input interface and/or an output interface. Some examples of the input interface may include, but are not limited to, a keyboard, a mouse, a joystick, a keypad, a touch screen, soft keys, a microphone, and the like. Some examples of the output interface may include, but are not limited to, a microphone, a speaker, a ringer, a vibrator, and the like.

In an example embodiment, the processor 902 may include I/O circuitry configured to control at least some functions of one or more elements of I/O module 906, such as, for example, a speaker, a microphone, a display, and/or the like. The processor 902 and/or the I/O circuitry may be configured to control one or more functions of the one or more elements of the I/O module 906 through computer program instructions, for example, software and/or firmware, stored on a memory, for example, the memory 904, and/or the like, accessible to the processor 902.

The communication interface 908 enables the merchant networking device 900 to communicate with other entities over various types of networks, such as for example, wired or wireless networks or combinations of wired and wireless networks, such as for example, the Internet. To that effect, the communication interface 908 may include a transceiver circuitry configured to enable transmission and reception of data signals over the various types of communication networks. In an embodiment, the communication interface 908 may receive connectivity requests from one or more electronic payment cards (e.g., the electronic payment card 106) for pairing with the merchant networking device 900. Further, the communication interface 908 is also configured to receive payment transaction request from electronic payment cards (e.g., the electronic payment card 106) for performing payment transactions via the merchant networking device. The communication interface 908 may include relevant application programming interfaces (APIs) to provide a device identifier for the electronic payment cards paired with the merchant networking device 900, modify a flag identifier for indicating that the payment transaction request is from the electronic payment card, send the payment transaction request for further processing of the payment transaction and send/receive status of the payment transaction.

In an embodiment, various components of merchant networking device 900, such as the processor 902, the memory 904, the I/O module 906 and the communication interface 908 may be configured to communicate with each other via or through a centralized circuit system 910. The centralized circuit system 910 may be various devices configured to, among other things, provide or enable communication between the components (902-908) of the merchant networking device 900. In certain embodiments, the centralized circuit system 910 may be a central printed circuit board (PCB) such as a motherboard, a main board, a system board, or a logic board. The centralized circuit system 910 may also, or alternatively, include other printed circuit assemblies (PCAs) or communication channel media.

The merchant networking device 900 as illustrated and hereinafter described is merely illustrative of a system that could benefit from embodiments of the invention and, therefore, should not be taken to limit the scope of the invention. It may be noted that the merchant networking device 900 may include fewer or more components than those depicted in FIG. 9. As explained above, the merchant networking device 900 may be included within or embody an electronic device. Moreover, the merchant networking device 900 may be implemented as a centralized system, or, alternatively, the various components of the merchant networking device 900 may be deployed in a distributed manner while being operatively coupled to each other.

It will be appreciated that many functionalities of the merchant networking device 900 can be performed by user devices such as, mobile phones or server systems or a combination thereof.

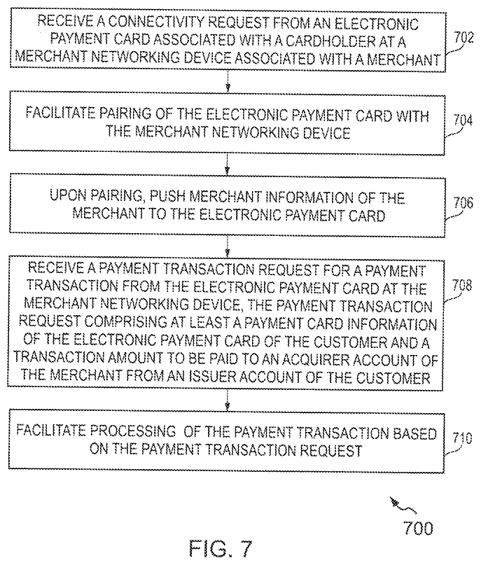

FIG. 10 is a simplified block diagram of a server system 1000 used for facilitating a payment transaction with a payment card, in accordance with one embodiment of the present disclosure. Examples of the server system 1000 include, but are not limited to, the acquirer server 112, the payment server 114 and the issuer server 118 illustrated in FIG. 1. The server system 1000 includes a computer system 1005 and a database 1010. The computer system 1005 includes at least one processor 1015 for executing instructions. Instructions may be stored in, for example, but not limited to, a memory 1020. The processor 1015 may include one or more processing units (e.g., in a multi-core configuration).

The processor 1015 is operatively coupled to a communication interface 1025 such that the computer system 1005 is capable of communicating with a remote device such as a merchant networking device 1035 (e.g., the merchant networking device 108) or communicating with any entity within the payment network 116. For example, the communication interface 1025 may receive the payment transaction request for processing a payment transaction received from an electronic payment card via the merchant networking device 108.

The processor 1015 may also be operatively coupled to the database 1010. The database 1010 is any computer-operated hardware suitable for storing and/or retrieving data, such as, but not limited to, transaction data generated as part of sales activities conducted over the bankcard network including data relating to merchants, account holders or cardholders, and purchases. The database 1010 may also store information related to a plurality of user's issuer accounts. Each user account data includes at least one of a cardholder name, a cardholder address, an account number, MPIN, and other account identifier. The database 1010 also includes instructions for settling transactions between issuer account and merchant account including merchant bank account information. The database 1010 may include multiple storage units such as hard disks and/or solid-state disks in a redundant array of inexpensive disks (RAID) configuration. The database 1010 may include a storage area network (SAN) and/or a network attached storage (NAS) system.

In some embodiments, the database 1010 is integrated within the computer system 1005. For example, the computer system 1005 may include one or more hard disk drives as the database 1010. In other embodiments, the database 1010 is external to the computer system 1005 and may be accessed by the computer system 1005 using a storage interface 1030. The storage interface 1030 is any component capable of providing the processor 1015 with access to the database 1010. The storage interface 1030 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1015 with access to the database 1010.

The processor 1015 is configured to facilitate a transaction from an issuer account to an acquirer account (i.e. merchant account). The processor 1015 is configured to perform one or more functions such as: receiving the payment transaction request, authenticating the payment transaction and notifying the cardholder about a status of the payment transaction. Thereafter, the processor 1015 is configured to facilitate the transaction from the issuer account of the cardholder 104 to the acquirer account of the merchant 102. The processor 1015 may also be configured to notify the electronic payment card 106 of the transaction status via the communication interface 1025.

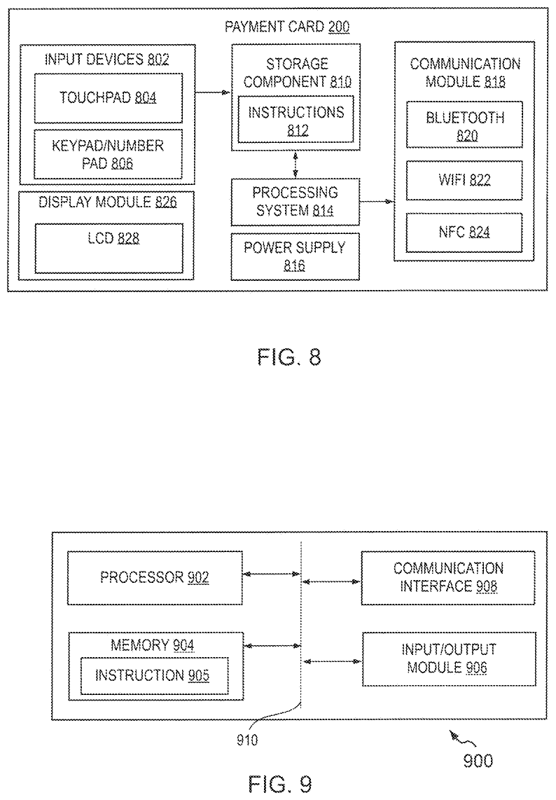

FIG. 11 is a simplified block diagram of an issuer server 1100, in accordance with one embodiment of the present disclosure. The issuer server 1100 is an example of the issuer server 118 of FIG. 1 or may be embodied in the issuer server 118. The issuer server 1100 is associated with an issuer bank/issuer, in which a cardholder may have an account, which provides a payment card (e.g., the electronic payment card 106). The issuer server 1100 includes a processing module 1105 operatively coupled to a storage module 1110, a verification module 1120 and a communication module 1125. The components of the issuer server 1100 provided herein may not be exhaustive and that the issuer server 1100 may include more or fewer components than that of depicted in FIG. 11. Further, two or more components may be embodied in one single component, and/or one component may be configured using multiple sub-components to achieve the desired functionalities. Some components of the issuer server 1100 may be configured using hardware elements, software elements, firmware elements and/or a combination thereof.

The storage module 1110 is configured to store machine executable instructions to be accessed by the processing module 1105. Additionally, the storage module 1110 stores information related to, contact information of the cardholder, bank account number, availability of funds in the account, payment card details, travel information of cardholders, and/or the like. This information is retrieved by the processing module 1105 for validation during machine-readable script generation.

The processing module 1105 is configured to communicate with one or more remote devices such as a remote device 1130 using the communication module 1125 over a network such as the payment network 116 of FIG. 1. The examples of the remote device 1130 include the merchant networking device 108, the electronic payment card 106, the payment server 114, the acquirer server 112 and/or other computing systems of the payment network 116 and the like. The communication module 1125 is capable of facilitating such operative communication with the remote devices and cloud servers using API (Application Program Interface) calls. The communication module 1125 is configured to receive the payment transaction request for processing the payment transaction.

The verification module 1120 is configured to verify and validate a user (such as the cardholder 104), the payment card 106 associated with the cardholder 104 and a PIN of the payment card for approving the payment transaction. The verification module 1120 may also verify if an issuer account of the cardholder associated with the payment card have good standing balance. The communication module 1125 is configured to send notification of approval or decline of a transaction and the machine-readable script to the merchant networking device 108 based on the merchant device identifier via the payment network 116.

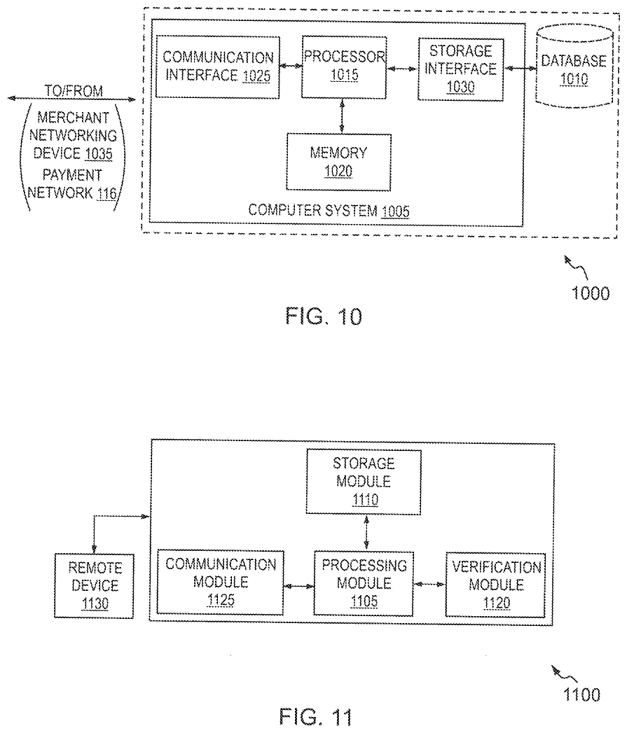

FIG. 12 is a simplified block diagram of an acquirer server 1200 used for facilitating payment transactions performed using the electronic payment card 106 via the merchant networking device 108, in accordance with one embodiment of the present disclosure. The acquirer server 1200 is associated with an acquirer bank, which may be associated with a merchant (e.g., the merchant facility 102) at whose facility the cardholder 104 is purchasing goods. The merchant may have established an account to accept payment for purchase of goods from cardholders. The acquirer server 1200 is an example of the acquirer server 112 of FIG. 1 or may be embodied in the acquirer server 112. Further, the acquirer server 1200 is configured to facilitate payment transactions with the issuer server 118 using the payment network 116 of FIG. 1. The acquirer server 1200 includes a processing module 1205 communicably coupled to a merchant database 1210 and a communication module 1215. The communication module 1215 is configured to receive the payment transaction request from the merchant networking device 108. Additionally, the processing module 1205 is configured to modify a flag identifier when the payment transaction request is received from the electronic payment card 106 via the merchant networking device 108.

The components of the acquirer server 1200 provided herein may not be exhaustive, and that the acquirer server 1200 may include more or fewer components than that of depicted in FIG. 12. Further, two or more components may be embodied in one single component, and/or one component may be configured using multiple sub-components to achieve the desired functionalities. Some components of the acquirer server 1200 may be configured using hardware elements, software elements, firmware elements and/or a combination thereof.

The merchant database 1210 includes a table which stores one or more merchant parameters, such as, but not limited to, a merchant primary account number (PAN), a merchant name, a merchant ID (MID), a merchant category code (MCC), a merchant city, a merchant postal code, an MAID, a merchant brand name, terminal identification numbers (TIDs) associated with merchant terminals (e.g., the POS terminals or any other merchant electronic devices) used for processing transactions, among others. The processing module 1205 is configured to use the MID or any other merchant parameter such as the merchant PAN to identify the merchant during the normal processing of payment transactions, adjustments, chargebacks, end-of-month fees, loyalty programs associated with the merchant and so forth. The processing module 1205 may be configured to store and update the merchant parameters in the merchant database 1210 for later retrieval. In an embodiment, the communication module 1215 is capable of facilitating operative communication with a remote device 1220 such as, the merchant networking device 108.

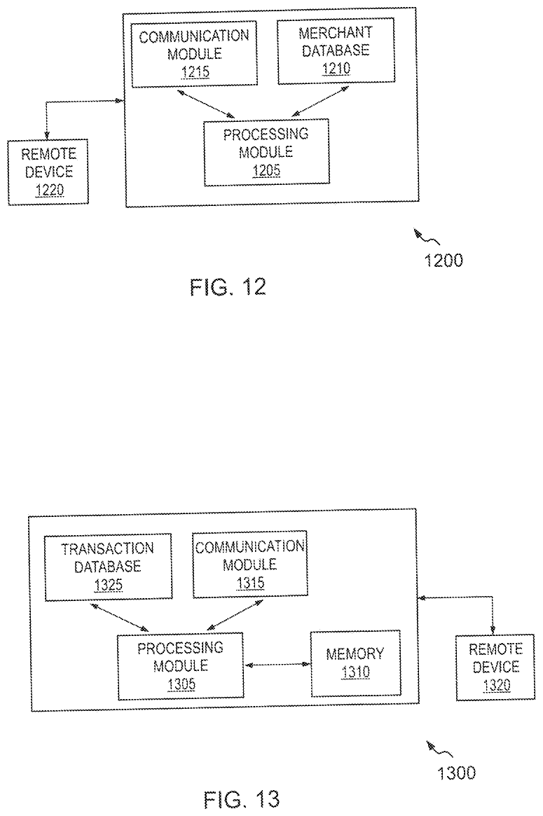

FIG. 13 is a simplified block diagram of a payment server 1300 used for facilitating payment transactions performed using the electronic payment card via a merchant networking device, in accordance with an embodiment of the present disclosure. The payment server 1300 is an example of the payment server 114 of FIG. 1. The payment network 116 may be used by the payment server 1300, the issuer server 1100 and the acquirer server 1200 as a payment interchange network. The payment server 1300 includes a processing system 1305 configured to extract programming instructions from a memory 1310 to provide various features of the present disclosure. The components of the payment server 1300 provided herein may not be exhaustive and that the payment server 1300 may include more or fewer components than that of depicted in FIG. 13. Further, two or more components may be embodied in one single component, and/or one component may be configured using multiple sub-components to achieve the desired functionalities. Some components of the payment server 1300 may be configured using hardware elements, software elements, firmware elements and/or a combination thereof.

Via a communication interface 1315, the processing system 1305 receives request from a remote device 1320 such as the acquirer server 1200. The request may be a payment transaction request from the acquirer server 1200. The communication may be achieved through API calls, without loss of generality. The payment server 1300 includes a database, such as a transaction database 1325. The transaction database 1325 may include transaction processing data, such as Issuer ID, country code, acquirer ID, among others. In addition, the processing system 1305 may store information of the merchant 102 and the cardholder 104.

Without in any way limiting the scope, interpretation, or application of the claims appearing below, a technical effect of one or more of the example embodiments disclosed herein is to provide an easy and convenient method of performing payment transactions at a merchant facility. Various embodiments provide methods and networking devices for facilitating a payment transaction with an electronic payment card of a cardholder precluding hassles of standing in long queues at merchant facilities to perform payment transactions. The cardholder can easily pair the electronic payment card with the merchant networking device and initiate the payment transaction. Moreover, the cardholder can authenticate the payment transaction securely via the electronic payment card without fear of identity theft using skimmers/scanners installed at POS terminals. Furthermore, the cardholder can pay for goods/services purchased from anywhere within the vicinity of the merchant networking device.

The disclosed methods with reference to FIGS. 1 to 13, or one or more operations of the flow diagrams 700 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 1000 (e.g., the servers 112, 114 and 118) and its various components such as the computer system 1005 and the database 1010 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method for performing a payment transaction at a merchant facility, comprising:
receiving a connectivity request from an electronic payment card associated with a cardholder at a merchant networking device associated with a merchant;
facilitating pairing of the electronic payment card with the merchant networking device;
upon pairing, pushing payment related information of the merchant to the electronic payment card;
receiving a payment transaction request for the payment transaction from the electronic payment card at the merchant networking device in response to pushing the payment related information, the payment transaction request comprising at least a payment card information of the electronic payment card of the cardholder and a transaction amount to be paid to an acquirer account of the merchant from an issuer account of the cardholder; and
facilitating processing of the payment transaction based on the payment transaction request.

2. The method as claimed in claim 1, wherein the electronic payment card includes a Wireless Fidelity (WiFi) receiver for communicating with the merchant networking device.

3. The method as claimed in claim 2, further comprising:
upon receiving the connectivity request, assigning a device identifier for the electronic payment card; and
storing the payment card information of the electronic payment card with the device identifier at the merchant networking device.

4. The method as claimed in claim 3, further comprising:
sending the payment transaction request to an acquirer server associated with the acquirer account for facilitating the payment transaction, wherein the payment transaction is processed between the acquirer server, an issuer server associated with the issuer account via a payment server in a payment network.

5. The method as claimed in claim 4, wherein processing the payment transaction comprises:
facilitating authentication of the payment transaction by the cardholder on the electronic payment card for processing the payment transaction.

6. The method as claimed in claim 4, wherein sending the payment transaction request comprises:
sending a merchant device identifier associated with the merchant networking device to the acquirer server along with the payment transaction request.

7. The method as claimed in claim 6, further comprising:
receiving a status of the payment transaction at the merchant networking device based on the merchant device identifier.

8. The method as claimed in claim 7, further comprising:
sharing the status of the payment transaction with the electronic payment card based on the device identifier.

9. The method as claimed in claim 1, wherein receiving the connectivity request comprises:
displaying a connectivity information associated with each merchant networking device of one or more merchant networking devices on the electronic payment card of the cardholder, each merchant networking device associated with at least one merchant of a plurality of merchants in a vicinity of the electronic payment card; and
receiving a selection of the merchant networking device from among the one or more merchant networking device for performing the payment transaction.

10. The method as claimed in claim 1, wherein the merchant networking device is a WiFi router.

11. The method as claimed in claim 1, wherein receiving the payment transaction request comprises:
modifying a flag identifier for indicating the payment transaction request being received from the electronic payment card via the merchant networking device.

12. A merchant networking device for facilitating payment transactions at a merchant facility, comprising:
a memory comprising stored instructions; and
at least one processor configured to execute the stored instructions to cause the merchant networking device to perform at least receiving a connectivity request from an electronic payment card associated with a cardholder, the cardholder being in vicinity of the merchant facility, facilitating pairing of the electronic payment card,
upon pairing, pushing merchant information of a merchant associated with merchant the merchant facility to the electronic payment card,
receiving a payment transaction request for the payment transaction from the electronic payment card in response to pushing the payment related information, the payment transaction request comprising at least a payment card information of the electronic payment card of the cardholder and a transaction amount to be paid to an acquirer account of the merchant from an issuer account of the cardholder, and
facilitating processing of the payment transaction based on the payment transaction request.

13. The merchant networking device as claimed in claim 12, wherein the merchant networking device is further caused to perform at least:
upon receiving the connectivity request, assigning a device identifier for the electronic payment card; and
storing the payment card information of the electronic payment card with the device identifier.

14. The merchant networking device as claimed in claim 13, wherein the merchant networking device is further caused to perform at least:
sending the payment transaction request to an acquirer server associated with the acquirer account for facilitating the payment transaction, wherein the payment transaction is processed between the acquirer server, an issuer server associated with the issuer account via a payment server in a payment network.

15. The merchant networking device as claimed in claim 14, wherein the merchant networking device is further caused to perform at least:
sending a merchant device identifier associated with the merchant networking device to the acquirer server along with the payment transaction request.

16. The merchant networking device as claimed in claim 15, further caused to perform at least:
sharing the status of the payment transaction with the electronic payment card based on the device identifier.

17. The merchant networking device as claimed in claim 12, wherein the merchant networking device is a Wi-Fi router.

18. An electronic payment card for performing payment transactions at a merchant facility, comprising:
a communication module configured to
send a connectivity request to a merchant networking device associated with a merchant for pairing with the merchant networking device, wherein a local identifier is assigned to the electronic payment card upon verifying the connectivity request, and
receive a merchant information of the merchant associated with the merchant networking device, the merchant information comprising at least a merchant identifier and details of the acquirer account of the merchant; and
a processing system in operative communication with the communication module, the processing system configured to
generate a payment transaction request for a payment transaction to the merchant networking device upon receiving the merchant information, the payment transaction request comprising at least a payment card information of the electronic payment card of the cardholder and a transaction amount to be paid to the acquirer account from an issuer account of the cardholder.

19. The electronic payment card as claimed in claim 18, further comprising:
an user interface; and
a display module in operative communication with the user interface and the processing module, the display module being configured to
display a connectivity information associated with each merchant networking device of one or more merchant networking devices for a cardholder, each merchant networking device associated with at least one merchant of a plurality of merchants, and
receive a selection on a merchant networking device of the one or more merchant networking device from the cardholder via the user interface for performing a payment transaction.

20. The electronic payment card as claimed in claim 18, wherein the communication module includes a Wireless Fidelity (WiFi) receiver for communicating with the merchant networking device
